(19) United States
(12) Patent Application Publication
(10) Pub. No.: US 2005/0120530 A1
(43) Pub. Date: Jun. 9, 2005

(54) Contoured jaw extractor tool and method

(76) Inventor: Kenneth E. Persson, East Rochester, NY (US)

Correspondence Address: KENNETH E. PERSSON, PO BOX 744, EAST ROCHESTER, NY, 14445, US

(21) Appl. No.: 10/727,693

(22) Filed: Dec. 4, 2003

(51) Int. Cl. B23P 19/00

(52) U.S. Cl. 29/270; 29/426.5; 29/426.1

(57) ABSTRACT

An extractor tool and method of the present disclosure are provided for extracting from a recess such as a keyway a removable item such as a broken key portion of a cut key where the broken key portion includes at least one key bitting slope. The extractor tool of the present disclosure includes a handle member; and a tool member having a first end for connecting to the handle member, and a second and distal end for inserting into the keyway containing the broken key portion. The second and distal end includes a contoured jaw section contoured for following the at least one key bitting slope on the broken key portion and for maximizing a contact area between the contoured jaw section and the key bitting slope.

### RELATED APPLICATIONS

This application is related to U.S. application Ser. No. ______ (patentee's docket KP004) entitled “Side Acting extractor tool”; having a common inventor, and filed on the same date herewith.

### BACKGROUND OF THE DISCLOSURE

This invention relates for example to locks of the kind having pin or other types of tumblers arranged to be displaced by an appropriately cut or cut key in order to enable opening of the lock by permitting a movable portion of the lock to be moved relative to the main body or cylinder of the lock. This invention more particularly relates to a method and an extractor tool having a contoured jaw for extracting broken pieces from a recess, for example, broken key portions of such keys from keyways of such locks. It will be convenient hereinafter to describe all aspects of this invention with particular reference to pin and wafer locks, but it is to be understood that the invention may be applied to other types of members having broken pieces therein, and to locks having other types of tumblers.

It is not uncommon for the end portion of a key to break off in a lock keyway, particularly an automobile ignition lock utilizing tumblers. Such automobile locks usually constitute the primary electrical switch for the vehicle and employ the key to impose a torque on the switch once the key is properly inserted, and keys are often bent or otherwise stressed due to the forces imposed thereon during use. When a portion of the automobile ignition key is broken off within the lock keyway or slot, such broken end is usually inaccessible, thus preventing the ignition switch from being operated and rendering the vehicle inoperative. Until the inaccessible broken key end portion is removed from the lock, operation of the vehicle is usually prevented. Broken key extractors are known and such devices may use a variety of tools for endeavoring to coax the broken key end from the lock. Adhesives, hook probes, and the like, may be used. However, the difficulty encountered in removing broken keys from locks often is so great that the lock must be entirely replaced at considerable expense.

U.S. Pat. No. 6,052,883 Apr. 25, 2000 and U.S. Pat. No. 6,260,253 issued Jul. 17, 2001, both to Kimzey each discloses a multiple, separate component extractor system tool for removing inaccessible broken key portions from keyways of locks. The extractor system tool consists of a separate pliers-like spreader tool for inserting into a keyway to displace any interfering tumblers, and a pair of thin elongated elements capable of being inserted into the lock on opposite sides of the broken key end portion and wherein twisting of the elements allegedly grips the broken key end to permit extraction from the lock. Extraction is aided by the pliers-like spreader tool having thin jaws inserted into the lock keyway for retracting lock tumblers, the dust shutter door and buzzer electric switches so as to prevent such items from interfering with the key extraction. As is obvious, this extractor system tool is not very convenient or efficient to use particularly because it literally requires three hands to use, one for each of the pair of elements and a third for the pliers-like spreader.

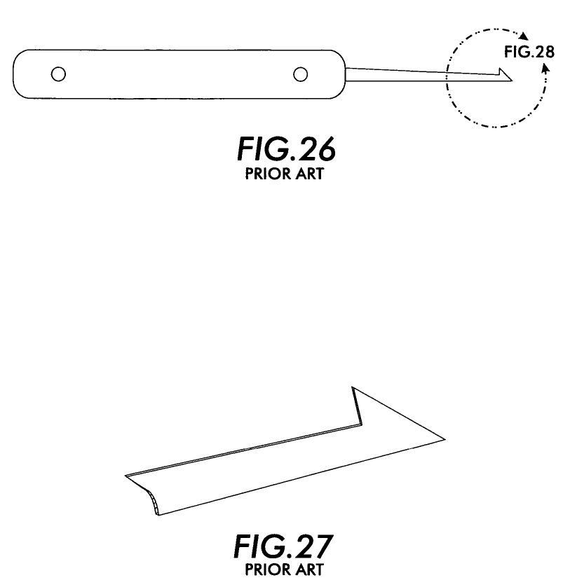

Other prior art such as disclosed in the last two figures, FIGS. 26 and 27, comprises a straight tool shaft having a single tooth or hook, usually a rigid shaft with a fixed, rigid tooth or hook intended for somehow grabbing the broken key portion from within the keyway. Such a prior art tool has been found not to have the angularity required to insure good tooth or hook bite into the broken key portion, and the single tooth or hook does not provide sufficient grabbing of the broken key portion for efficient extraction. This prior art tool also does not have tip or distal end features for enabling effective prying and ramping of tumbler pins resting partially or fully on the broken key portion within the keyway.

There is therefore still a need for a simple, single, one hand, effective and efficient extractor tool for efficiently extracting a loose item such as a broken key portion from a slot such as a keyway.

In addition to the many other aspects as claimed, the extractor tool and the method of the present disclosure provide a simple one tool, one hand, effective and efficient way of extracting broken key portions from keyways of almost any kind of lock. As illustrated and described, the extractor tool of the present disclosure is suitable for extracting from a keyway a broken key portion of a cut key. In fact the extractor tool of the present disclosure is suitable for extracting a removable piece from within any recess, provided the removable piece has a contact surface on which the single or multiple friction jaws of the tool can function. In a first embodiment, the extractor tool of the present disclosure comprises a single-axis acting device including a handle member; a tool member having a first end for connecting to the handle member, and a second and distal end for inserting into a recess such as a keyway containing the removable piece or broken key portion. The second and distal end includes a jaw section contoured to follow a contact surface area, such as a key bitting slope on the broken key portion, for making a single axis jaw contact with the contact surface, and for maximizing a contact area between the contoured jaw section and the contact surface.

In a second embodiment, the extractor tool of the present disclosure comprises a dual-axes acting mechanism. The dual-axes acting mechanism is suitable for extracting from a keyway a broken key portion of a double-edge key. The dual-axes acting mechanism is assembled from two single-axis acting devices each including a handle member; a tool member having a first end for connecting to the handle member, and a second and distal end for inserting into a recess such as a keyway containing the removable piece or broken key portion. The second and distal end of each single-axis acting device includes a jaw section contoured to follow a contact surface area, such as a key bitting slope on the broken key portion, for maximizing a contact area between the contoured jaw section and a contact surface. In the dual-axes acting mechanism, the two single-axis acting devices are attached together pivotably for opening and closing movements in a scissors manner, and so that the acting axis of one jaw is offset from and apposite relative to that of the other jaw, thereby enabling the mechanism to make two offset and apposite jaw-contacts, one with each edge of the double-edge broken key portion.

In an up and down positioned keyway, the dual-axes acting mechanism can be assembled for right-over-left (ROL) keyways so that the two jaws and their acting axes are offset left-to-right, and so that the acting axis of the right jaw during closing is from up to down, and that of the left jaw is from down to up.

Similarly, the dual-axes acting mechanism can also be assembled for left-over-right (LOR) keyways so that the two jaws and their acting axes are offset left-to-right, and so that the acting axis of the left jaw during closing is from up to down, and that of right jaw is from down to up.

The method of the present disclosure is suitable for extracting from a lock keyway having two spaced apart opposing side surfaces, two spaced apart opposing edges, a series of lock tumblers, and a longitudinal axis, a broken key portion including a broken end and at least one key bitting having a key bitting slope. In addition to the many other aspects as claimed, the method includes (a) longitudinally inserting into the lock keyway an extractor tool having a distal tip, a first edge, and a second edge including an extracting jaw having a friction surface contoured relative to the key bitting slope for maximizing contact between the friction surface and the key bitting slope within the lock keyway; (b) contacting the broken end of the broken key portion with the distal tip; (c) moving the first edge of the extractor tool towards one of the two spaced apart and opposing edges of the lock keyway; (d) further moving the distal tip and the contoured friction surface longitudinally into the keyway and the contoured friction surface into a contoured mating relationship with the key bitting slope; and (e) simultaneously pressing the contoured friction surface into the key bitting slope and pulling the extractor tool longitudinally back out of the keyway, thereby gripping the key bitting slope and extracting the broken key portion out of the keyway.

In a third embodiment, the extractor tool of the present disclosure comprises a triple-axes acting mechanism. The triple-axes acting mechanism is suitable for extracting from a recess, removable items including heavy items and items that can rotate within the recess. The triple-axes acting mechanism is assembled from three single-axis acting devices each including a handle member; a tool member having a first end for connecting to the handle member, and a second and distal end for inserting into the recess containing the removable item. The second and distal end of each single-axis acting device includes a jaw section contoured to follow a contact surface on the removable item and for maximizing a contact area between the contoured jaw section and a contact surface on the item. In the triple-axes acting mechanism, the three single-axis acting devices are attached together pivotably for opening and closing movements in a scissors manner, and so that the acting axis of one jaw is offset from, apposite to, and between the two other acting axes of the two other jaws, thereby enabling the mechanism to make three offset, apposite and non-torque jaw-contacts at three different points with the contact surface of the removable item.

In the detailed description of the invention as presented below, reference is made to the drawings in which:

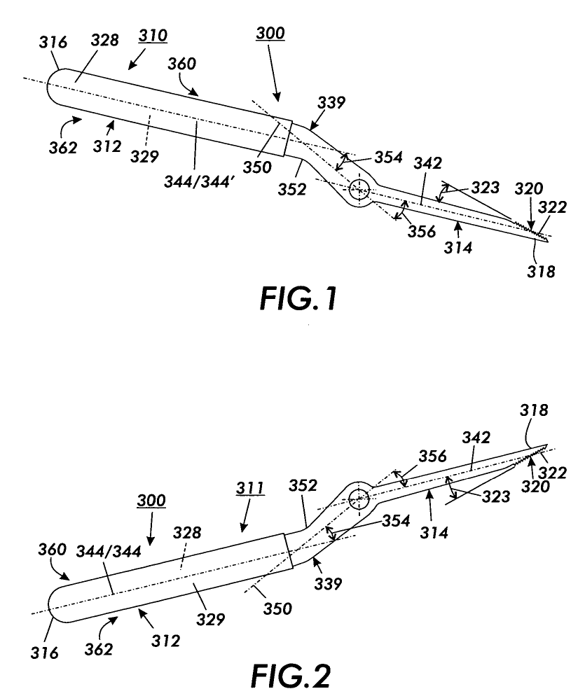

FIG. 1 is a schematic side view of a first embodiment comprising a single-axis acting device of the extractor tool of the present disclosure having a first side of two sides facing up;

FIG. 2 is the same as FIG. 1, but with the second side of two sides facing up;

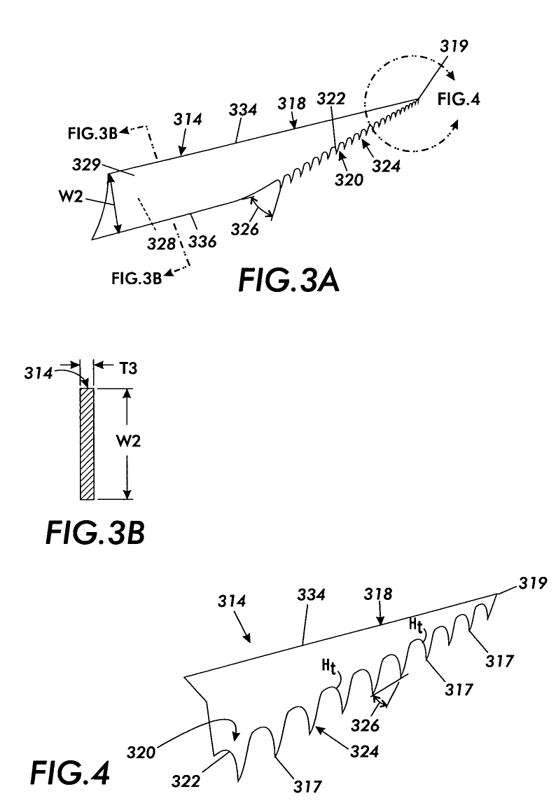

FIG. 3A is an enlarged illustration of the contoured jaw section of the tool of FIGS. 1 and 2;

FIG. 3B is a cross-section of the tool member of the extractor tool of FIGS. 1 and 2;

FIG. 4 is an illustration of further details of the contoured jaw section of FIG. 3A;

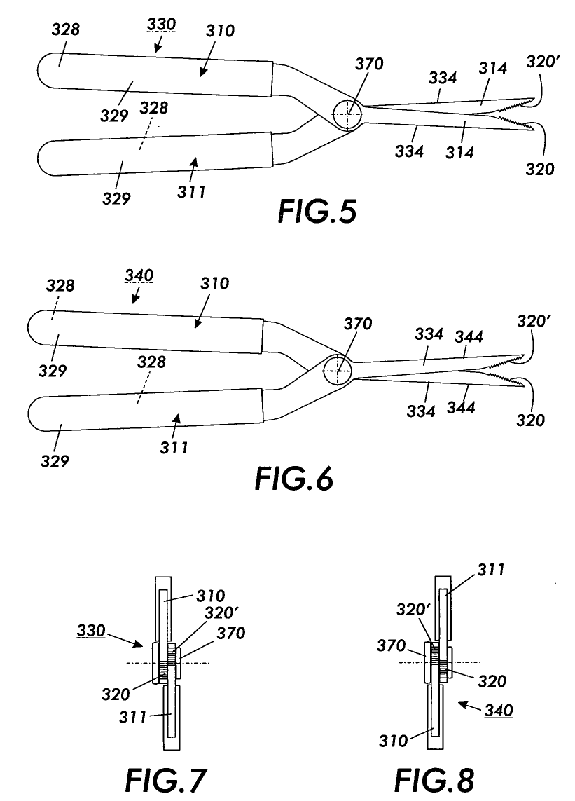

FIG. 5 is a schematic side view of a second embodiment comprising a left-over-right (LOR) dual-axes acting mechanism of the extractor tool of the present disclosure;

FIG. 6 is a schematic side view of the second embodiment comprising a right-over-left (ROL) dual-axes acting mechanism of the extractor tool of the present disclosure;

FIG. 7 is a schematic front end view of the second embodiment (left-over-right) of FIG. 5;

FIG. 8 is a schematic front end view of the third embodiment (right-over-left) of FIG. 6;

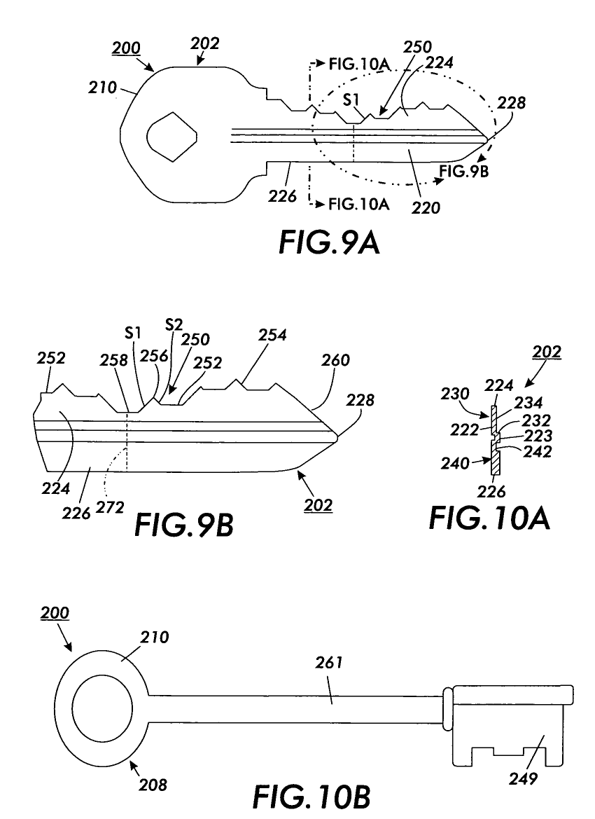

FIGS. 9A-9B are each a side view illustration of an exemplary single-edge cut key for use in accordance with the present disclosure;

FIG. 10A is a cross-sectional illustration of the exemplary single-edge cut key of FIG. 9A;

FIG. 10B is an illustration of a skeleton key;

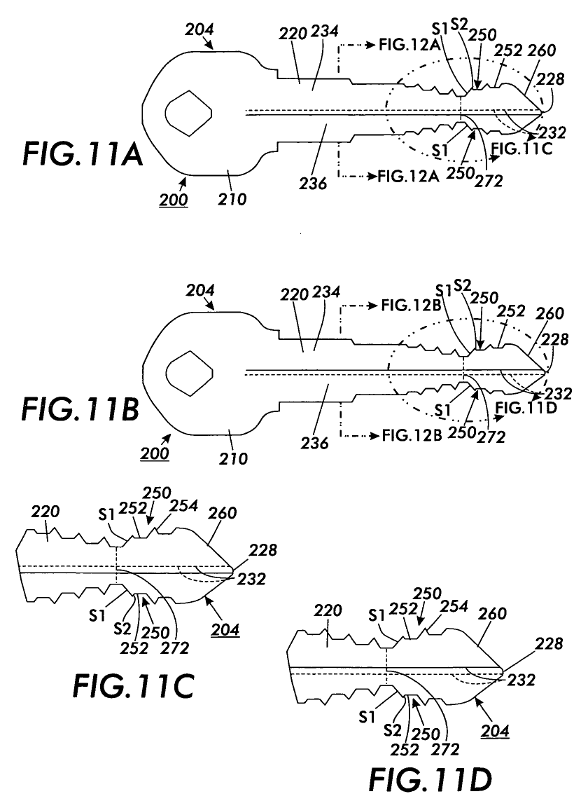

FIGS. 11A and 11B are each a side view illustration of an exemplary dual-edge cut key (left-over-right and right-over-left respectively) for use in accordance with the present disclosure;

FIGS. 11C and 11D are each an enlarged illustration of the keys of FIG. 11A and 11B showing key bittings including humps and valleys in detail;

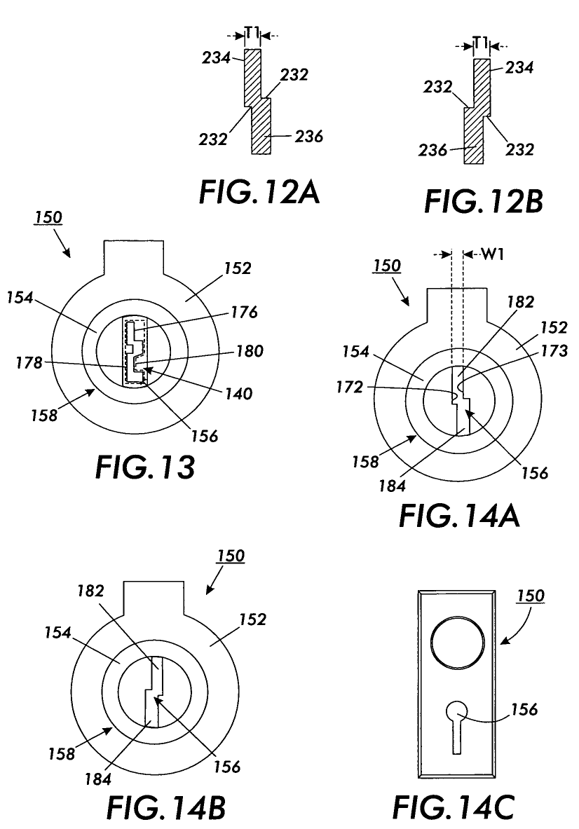

FIGS. 12A and 12B are each a cross-sectional illustration of the exemplary dual-edge cut keys of FIGS. 11A and 11B respectively;

FIG. 13 is an end view of a keyway of a lock for a single cut key;

FIGS. 14A-14B are each an end view of left-over-right and right-over-left keyways of cylinder locks for double cut keys;

FIG. 14C is an end view of a keyway of a lock for a skeleton key;

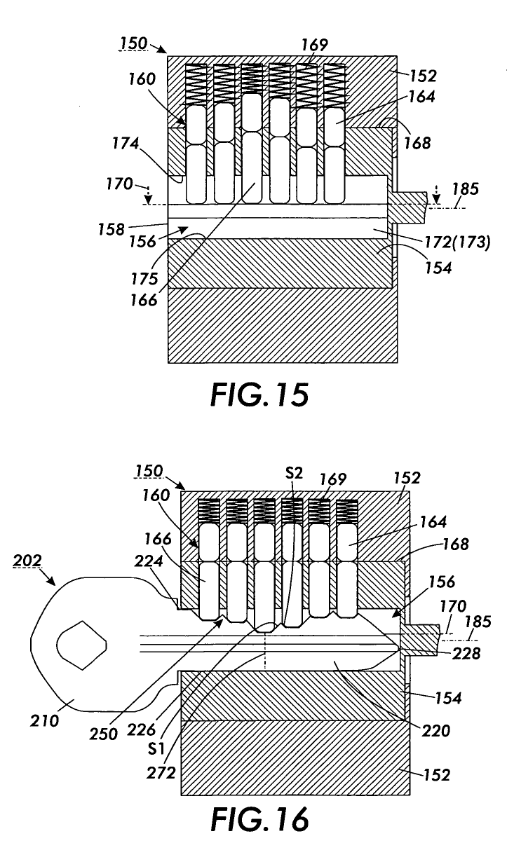

FIG. 15 is an enlarged longitudinal cross sectional view of an exemplary lock, for example a pin lock having an end view as in FIGS. 14A-14B;

FIG. 16 is a schematic longitudinal cross sectional view of an exemplary lock, for example a single pin-series lock showing a correct single-edge cut key inserted therein;

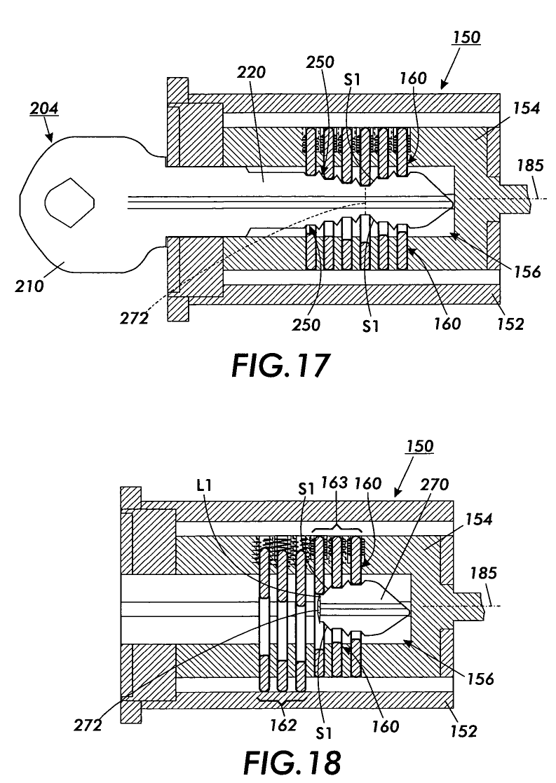

FIG. 17 is a schematic longitudinal cross sectional view of an exemplary lock, for example a wafer lock, showing a correct dual-edge cut key inserted therein;

FIGS. 18-20 are illustrations similar to FIGS. 16 and 17 showing broken key portions within lock keyways requiring extraction;

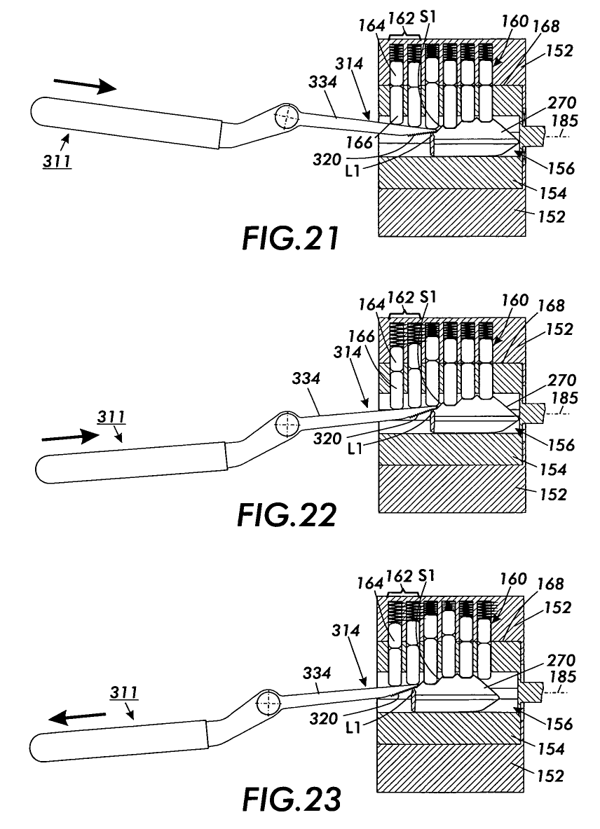

FIGS. 21-23 are schematic illustrations of several stages of the first embodiment of the extractor tool of the present disclosure extracting the broken key portion of FIG. 18 out of the keyway;

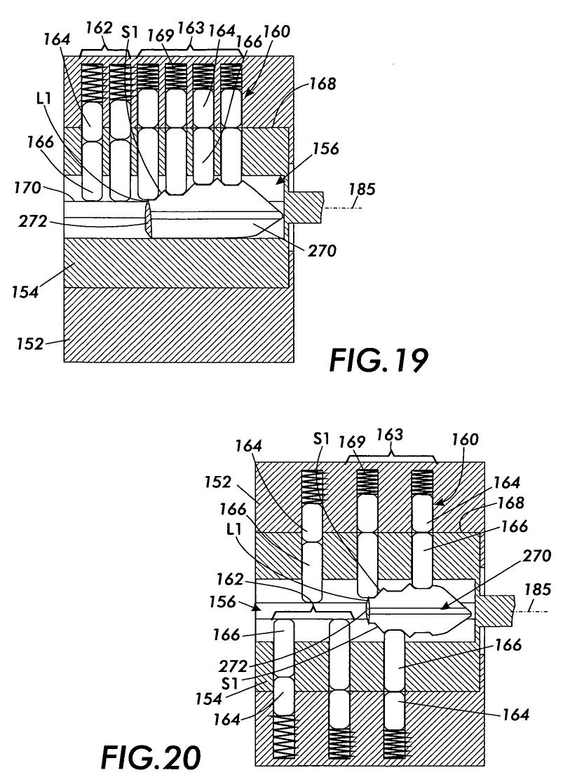

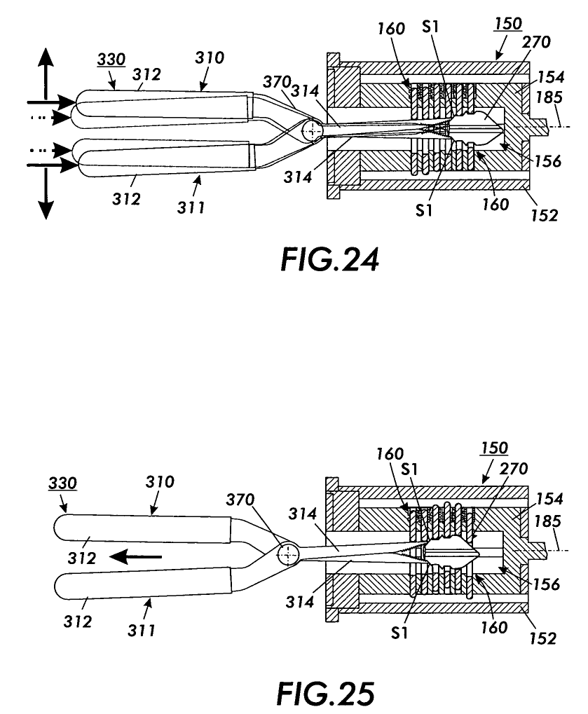

FIGS. 24-25 are schematic illustrations of stages of the second embodiment of the extractor tool of the present disclosure extracting the broken key portion of FIG. 19 out of the keyway;

FIGS. 26 and 27 are illustrations of an exemplary Prior Art tool having a straight tool shaft including a single tooth or hook;

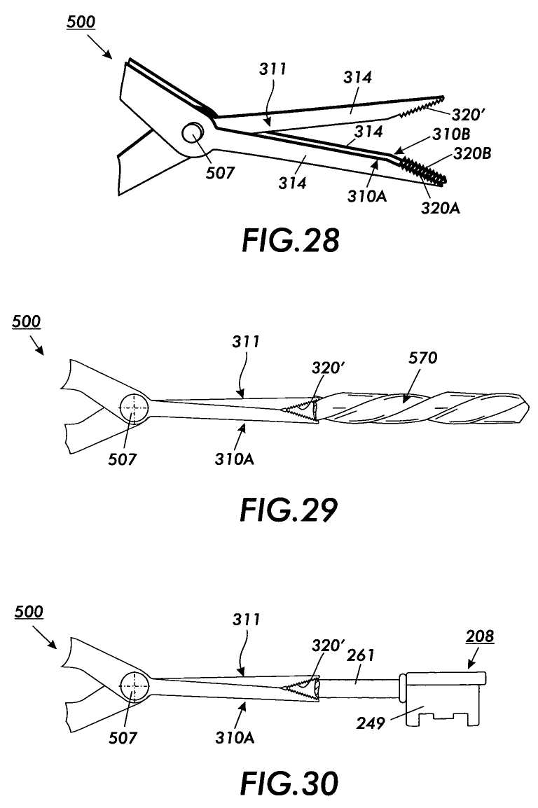

FIG. 28 is a schematic perspective illustration of a third embodiment comprising a triple-axes acting mechanism of the extractor tool of the present disclosure;

FIG. 29 is an illustration of the triple-axes acting mechanism tool of FIG. 28 gripping a rotatable drill bit for extraction;

FIG. 30 is an illustration of the triple-axes acting mechanism tool of FIG. 28 gripping a broken round stem of a skeleton key for extraction;

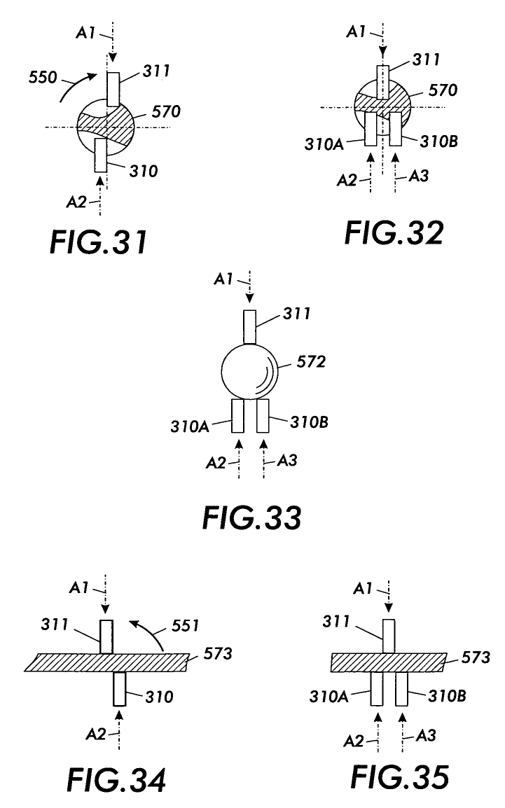

FIG. 31 is an illustration of a ROL dual-axes acting mechanism being ineffective in gripping a rotatable drill bit for extraction;

FIG. 32 is an illustration of the triple-axes acting mechanism of the present disclosure effectively gripping a rotatable drill bit for extraction;

FIG. 33 is an illustration of the triple-axes acting mechanism of the present disclosure effectively gripping a rotatable spherical item for extraction;

FIG. 34 is an illustration of a ROL dual-axes acting mechanism being ineffective in gripping a rotatable plate item for extraction;

FIG. 35 is an illustration of the triple-axes acting mechanism of the present disclosure effectively gripping a rotatable plate item for extraction.

### DETAILED DESCRIPTION OF THE DISCLOSURE

While the present disclosure will be described in connection with a preferred embodiment thereof, it will be understood that it is not intended to limit the invention to that embodiment. On the contrary, it is intended to cover all alternatives, modifications, and equivalents as may be included within the spirit and scope of the invention as defined by the appended claims.

Referring now to FIGS. 13-25, locks 150 suitable for use with the present invention are illustrated. FIG. 13 is a front view of a lock 150 for a single cut key 202, and FIGS. 14A-14B are each a view of an end 158 of various keyways of a cylinder lock 150 for example as described above. FIG. 14C is an illustration of the front of a skeleton lock. FIG. 15 is an enlarged longitudinal cross sectional view of an exemplary lock, for example a pin tumbler lock having an end 158 as in FIGS. 14A-14B. FIG. 16 is a schematic longitudinal cross sectional view of the exemplary lock 150, for example a single pin tumbler lock 150 showing a correct single-edge cut key 202 inserted therein. FIGS. 17-18 are each a schematic longitudinal cross sectional view of an exemplary lock, for example a wafer lock, showing a correct dual-edge cut key 204 inserted therein.

Still referring to FIGS. 13-20, the keyway 156 as shown is linearly cut through the plug or inner cylinder 154. As viewed in cross section or from its end 158 (FIGS. 13-14C), the typical keyway 156 for a single-edge cut key 202 includes an upper portion 176 for receiving the bladed section 230 (FIG. 10A) of a key, and a lower portion 178 for receiving the warded section 240 of the key 202. As illustrated in FIGS. 15-20, the moveable locking members, such as wafers or pins 160 are located linearly along the length or depth of the keyway 156 resulting in a multitude of combination locking points that a cut key 202, 204 must simultaneously defeat in order to allow the inner plug 154 to turn.

Referring first to FIGS. 13-17, a lock 150 that is useful for the purposes of the present disclosure, usually has a front end 158 and a keyway 156 as shown in FIGS. 13-14C. Then as illustrated starting from FIG. 15, the lock 150 is comprised of a housing or outer cylinder 152, and a movable member or plug 154, for example a rotatable member that has the keyway 156 formed into it for receiving a key. Such a lock also includes locking devices or tumblers, such as pins or wafers 160, located partially within the movable member or plug 154. These locking devices are operatable by only the correct key 202, 204 (FIGS. 16-20) for correctly displacing all the pins or wafers 160 out of interference within the keyway and thus allowing or enabling movement of the movable member or plug 154 within the housing 152.

As shown in FIG. 15, generally, the keyway 156 has two oppositely facing and spaced apart wall surfaces 172, 173, a first edge, usually an upper edge 174, and a second and opposite edge, usually a bottom edge 175, with each of these edges extending longitudinally from the front end or external opening 158, into the movable member or plug 154. For each lock and correct key combination, the keyway 156 is formed deep enough for completely accommodating a length of the front or shaft portion 220 (FIG. 11A) of the correct key 200. The keyway as such also has a width W1 (FIG. 14A for example) lying between the two opposite wall surfaces 172, 173, and such width is generally represented by a width of the upper and lower keyway edges 174, 175, but is further reduced by ward or key entry restricting features 180, 171 within the warded portion of the key way.

As is well known, these pins or wafers 160 as illustrated in FIGS. 15-25, are able to move with the aid of springs 169 within limits established inside the channels or guide ways 167 machined into the lock's plug 154 and cylinder 152. The downward travel of these pins allows each to get to their lowest or locking and keyway interfering positions 170 (FIG. 15) when released, or when there is no key to hold them up, but is constrained in order to prevent the pins from falling out of their travel channel 167.

Accordingly, as illustrated in FIGS. 15-25, a lock 150 that includes a cylinder or housing 152, a rotatable barrel 154 as the movable member mounted inside the cylinder 152, is an excellent example of a lock useful in accordance with the present disclosure. A lock as such thus includes the keyway 156 formed through the front end 158 of the barrel and extending inwardly of the barrel in the longitudinal direction. For locking devices, the lock for example may include groups of pin tumblers (FIGS. 15-16) or wafers (FIGS. 17-18) 160 that are mounted partially in the cylinder 152 and in the barrel 154 with each group or series thereof being movable towards and away from a longitudinal axis 185 of the rotatable barrel 154.

As further illustrated in FIG. 15, each group of pin tumblers 160 typically includes a first (for example upper) pin 164 and a second (or lower) pin 166, with the lower pin 166 of each group being mounted to move and intrude or interfere through part of the movable member or plug 154 into the keyway 156 in the absence of a correct key. Insertion of the correct key into such a lock (FIGS. 16 and 17) first moves or displaces the intruding tumbler pins or wafers 160 out of the keyway 156. In the pin tumbler lock, as illustrated in FIG. 16, the correct key also aligns the first and second pins 164, 166 of each group of pins at a shear line 168 that lies between the housing 152 and the barrel 154 so as to allow the barrel 154 to rotate within the cylinder or housing 152.

The terms “upper” and “lower” as used throughout the specification to describe the key 200, key blade 234, 236 and keyway 156, are not to be understood as limiting the disposition of those components. Such relative terms are used for convenience of description only and in actual use, the upper edge surface 226 for example may be located to the side or underneath. In the preferred construction hereinafter described, the upper edge surface 174 of the keyway is that edge through which the pin tumblers for a single-edge cut key intrude into the keyway 156. The corresponding edge surface 226 of a single-edge cut key 202 is that edge containing the cuts or bittings 250. Thus such locks 150 typically are installed with the locking pins 160 located on a top side so that dirt does not fall into channels within which these pins, wafers and working mechanisms are located. As such, we can refer to the part of the lock having the pin sets as being the top of the lock.

In other words, an exemplary lock for use with the present disclosure is a mechanical lock such as a lock 150 that has a housing or shell cylinder 152, a rotatable plug or inner cylinder 154, a keyway 156 formed longitudinally through the plug 154, and moveable locking members such as mechanical pins or wafers 160 that can be raised or lowered by insertion of a correct cut key 200 inserted through the keyway 156 into the lock. Insertion of the correct cut key causes repositioning of these pins or wafers 160 from their lowest or locking and keyway interfering positions 170 (FIG. 15) back to alignment at their opening or shear line aligning positions 168, thereby allowing the inner cylinder or plug 154 to turn or rotate inside the lock housing or cylinder shell 152. Such rotation typically causes blocking sidebars (not shown), for example, to fall into a gap (not shown), thereby releasing the locking mechanism. Through various methods of attachment this turning of the inner plug facilitates some external movement that disengages a locking pawl or other security device allowing access to the item being protected by the lock.

Referring now to FIGS. 9A-12B, FIGS. 9A-10A are side view illustrations of an exemplary single-edge cut key 202 (for use in accordance with the present disclosure) showing the humps 254, valleys 252, and details thereof relevant for the operation of the present disclosure. FIG. 10B is an illustration of a skeleton key 208 having a handle 210, a shaft 261 and a blade portion 249.

Similarly, FIGS. 11A-12B are side view illustrations of an exemplary dual-edge cut key 204 (for use in accordance with the present disclosure) also showing the humps 254, valleys 252, and other details thereof relevant for the operation of the present disclosure. In particular, FIGS. 11A, 11C and 11B, 11D are each a side view illustration of dual-edge cut keys whose broken key portion 270 will be suitable for extraction by a left-over-right version 330 and right-over-left version 340, (FIGS. 5-8) respectively of the extractor tool 300 of the present disclosure. The difference between the key of FIG. 11A, 11C and that of FIG. 11B, 11D is the side on which the waisting groove 232 is located, thus making the key blades 234, 236 right-over-left or left-over-right. FIGS. 12A and 12B are each a cross-sectional illustration thereof respectively showing the left-over-right and right-over-left nature of the key blades 234, 236.

In general, a key shown as 200, whether a single-edge cut key 202 as in FIGS. 9A-10B, or a dual-edge cut key 204 as in FIGS. 11A-12B, usually includes a rear or grip portion called the bow 210, and an elongate front or shaft portion 220 having two oppositely facing side surfaces 222, 223, an upper edge 224 and a lower or bottom edge 226. Each of the two oppositely facing side surfaces 222, 223, the upper edge 224 and the lower or bottom edge 226, each extend from the bow 210 to a distal end or tip 228 of the shaft portion 220. The shaft portion 220 as such has a general thickness T1 (FIGS. 12A, 12B) lying between the two oppositely facing sides 222, 223.

In some cases however, the key as well as key blank as shown in FIG. 10A may include at least one waisting groove or recess 232 formed in at least one of the oppositely facing side surfaces 222, 223 and at a location adjacent to at least one of the upper and lower edges 224, 226 to form the key blade 234, 236 having a reduced thickness that is less than the general thickness T1 of the shaft portion 220. The waisting groove 232 as such usually extends longitudinally along the shaft portion 220 from the bow or grip portion 210 to the distal end 228, thus causing a bladed section, for example an upper bladed section 230 that is coincident with a blade 234, to lie to the left or right of a vertical axis of the key shaft 220, as well as adjacent the upper edge 224. In a dual-edge cut key, this is what makes the key and keyway right-over-left (ROL) or left-over-right (LOR) in profile (FIGS. 14A-14B, and 12A-12B) As shown in FIG. 10A, in the single-edge cut key 202, it also has a warded or lower section 240 including a ward groove 242 for receiving the ward 180 within the keyway 156. In a dual-edge cut key, there are two blades 234, 236, being an upper and a lower blade.

Typically as illustrated in FIGS. 9A-11D, a particular key is formed from a key blank by cutting or forming (in at least one or both of an upper and lower edges 224, 226 of blades 234, 236 of the shaft portion 220), a series of key cuts or bittings 250 that normally vary from one another in the their depths. The series of cuts or bittings 250 as illustrated in FIGS. 9B, 11C and 11D is comprised of a plurality of valleys 252 and humps 254 that alternate in the longitudinal direction of the shaft portion 220 from the grip portion 210 to the distal end 228 thereof. Each hump 254 has an apex 256 representing its highest point. Each apex (or appositely located apexes on the upper and lower edges in the case of a dual-edge cut key) forms a relatively wide section of the shaft portion. Each hump as such has a first slope S1 inclining for example upwards from a first adjacent valley 252 to the apex 256, and a second slope S2 (FIGS. 11C, 11D) declining from the apex 256 into a second adjacent valley 252.

On the other hand, each valley 252 has a root 258 representing its lowest point with each root or appositely located roots on the upper and lower edge surfaces forming “narrow sections” of the shaft portion 220. Each valley 252 as such also shares the two slopes S2 (which at the same time is the second slope to a first adjacent hump) declining for example downwards from the apex 256 of a first adjacent hump 254 to the root 258, and S1 (which at the same time is the first slope to a second adjacent hump) inclining upwards from the root 258 to the apex 256 of a second adjacent hump.

Specifically, as shown in FIGS. 9A-11D, a single-edge cut or a dual-edge cut key 202, 204 respectively, has the rear portion or bow 210 for gripping or holding onto, and an elongate, thin front or shaft portion 220 extending forwardly of the bow 210. The front or shaft portion 220 includes first and second sides 222, 223, the blade edge or edges 224, 226, and a warded portion 240. The warded portion 240 includes a mechanical feature, for example a ward groove 242. The absence, presence and precision of such mechanical feature 242 allow or restrict what key will fit in what lock. The blade 234 and upper edge 224 typically include the bittings or cuts 250 that form the combinated mechanical code for correctly manipulating the pins or wafers 160 in a particular lock 150. The distal end or tip 228 of the front or shaft portion 220 of the key usually includes a double edge taper 260 (FIG. 9B, giving the tip 228 a pointed shape. This allows the key on being inserted into the keyway 156, to gradually and easily lift each of the pins or wafers 160 from their lowest at-rest position 170, and to allow the lifted pins in particular to ride up and down the cut edge 224 of the key blade 234.

In order to further assist the pins 160 to glide up and down the cut edge 224 of the key blade 234, cuts or bittings 250 are formed as the humps 254 and valleys 252 with tapered sides comprising rising or inclining slopes S1 (moving bow to tip) and falling or declining slopes S2. Each of the tapered sides or slopes S1, S2 thus acts as a ramp allowing the pins 160 to glide up and down the cut edge 224 of the key blade 234.

The cuts or bittings 250 on the blade 234 of the correct key are formed so as to coincide or be aligned with the positioning within the lock (FIG. 15) of the pins or wafers 160. The combination (combinating) effect of these cuts 250 is accomplished by creating a depth of a cut for each pin position that correctly positions the physical boundary between the upper pin 164, and lower pin 166 of each set of pins, at the shear line 168 or at a side-bar acceptance position. This allows all blocking features of these devices to be neutralized, and thereby enables rotational movement of the inner cylinder or plug 154.

As illustrated in FIGS. 11A-11D, a dual-edge cut key 204 is comprised of the bow 210, a shaft portion 220 having two blades 234, 236, and instead of a warded section, it has a junction between the two blades. Dual-edge cut keys 204 as such are usually designed with identical cuts or bittings 250 on the bladed edges 224, 226 in order to allow a user the freedom to put the key in an upside down or downside up manner, and still have the key enter a single pin-series lock (FIG. 16) and operate the single series of pins therein. This freedom is particularly useful when trying to insert an automobile key into an automobile lock when it is dark. As further illustrated, a dual-edge cut key 204 is also useful in locks, such as wafer locks that have alternately dispersed wafers 160 on two opposite sides (FIG. 17-18).

Again, FIG. 10B is an illustration of a skeleton key 208 having a handle 210, a shaft 261 and a blade portion 249. As will be illustrated below, a break in such a key typically will occur along the cylindrical shaft 261, and the triple-axes acting embodiment 500 of the present invention (FIG. 28) is suitable for extracting the broken portion.

When forming cuts in a key blank to create a key, it will be noticed that the strength of the key is lessened or is least at the root or lowest point 258 of the deepest cut or valley 252, due to the cutting away of material. In the case of a dual-edge cut key with identical cuts on both edges 224, 226 this inherent weakness would be exaggerated due to the cut occurring on both sides of the key blank.

Given prolonged use, during which the sides of the key are worn out from being inserted, turned, twisted and withdrawn many times, it is common for some keys to break at the root or lowest point 258 of the deepest cut or valley 252 where the shaft of the key is relatively the narrowest. This is because the metal of the key shaft portion 220 has been fatigued by the normal habit of applying some rotational or twisting motion after insertion in order to operate the lock. Typically, the point of such a break lies a number of cuts forward of the bow 210 of the key, and hence the remnant or unbroken key portion of the broken key (that is, the portion of the shaft still attached to the bow) has a number of cuts in it too. As such, upon removing the bow and this unbroken key portion from the keyway, some pins 162 of the pins and wafers 160 that were initially held in their upwards or opening position by the cuts in the unbroken key portion, will now be released and fall to their at-rest or keyway interfering and locking positions 170 ahead or upstream of a broken key portion 270 that is still within the keyway. This effectively traps the broken key portion 270 within the keyway 156, and behind such released pins 162.

In other words, if cut keys or keys with bittings or cuts 250 formed in them break (when inserted into a lock and being turned in an attempt to open the lock), the break 272 will normally occur at a root 258 of a valley 252 (of the series of valleys and humps of the bittings) because the root 258 of the valley as such is one of the “narrow sections” of the shaft portion 220.

As such, it has been found (as illustrated in FIGS. 18 and 19) that the unbroken key portion that is removable with the bow 210 typically ends with a declining or second slope S2 declining from an apex 256 of a hump into the root 258 of the valley where the break 272 occurred. On the other hand, the broken key portion 270 left within the keyway 156 and needing to be extracted, typically starts with a corner lip L1 or an inclining or first slope S1 inclining from the root 258 of the valley where the break 272 occurred upwardly to the apex 256 of the next hump. These findings are true for single-edge cut as well as double-edge cut keys. Because there is usually enough longitudinal spacing within each such root 258 in order for it to hold the bottom of a pin 166, a line break 272 will usually leave a corner lip L1 ahead of the inclining slope S1 on the broken key portion 270.

Accordingly, in order to extract the broken key portion 270 from behind the released pins 162, one must (1) reach into the keyway 156, (2) raise the released pins or wafers 162 that are blocking the broken key portion 270 within the keyway, (3) grasp the broken key portion, and (4) withdraw the broken key portion while keeping the released pins 162 out of its way. Such a multiple tasked activity can be difficult and is conventionally accomplished with two hands, three tools, and with a flashlight in ones mouth in order to facilitate viewing of these critical elements all at the same time. This difficulty is increased even more in the case of a dual-edge cut automotive key where wafers must be withheld from two directions while attempting to grasp and extract the broken key portion.

Referring now to FIGS. 1-4, the extractor tool 300 of the present disclosure has several embodiments illustrated as 310, 311 (single-axis acting versions, FIGS. 1 and 2), 330 and 340 (each a dual-axes acting version, FIGS. 5 and 6), and 500 a triple-axes version (FIG. 28). As illustrated, FIG. 1 is a schematic plan view of a first version of the first embodiment of the extractor tool of the present disclosure showing a single-axis acting device 310 having a tool portion 314 with its first side 328 facing up, and hence its second side 329 facing down. FIG. 2 is an illustration of a second version 311 of the same single-axis acting device 310 laid down oppositely to its position in FIG. 1, meaning that the tool portion 314 has its first side 328 facing down, and hence its second side 329 facing up.

Each embodiment is suitable for extracting from a keyway 156, a broken key portion 270 that includes at least a contact surface segment such as a corner lip L1 or a key bitting slope S1 (FIGS. 21-25). The only difference between the embodiments 310 and 311 is whether the tool is placed on a surface with a first side thereof or a second side thereof facing down, as will be described below. Thus each of the extractor tool 310, 311 as such is a single-axis acting device that includes a handle member 312; and a tool member 314 having a first end 316 for connecting to the handle member 312. The tool member 314 also includes a second and distal end 318 for inserting into the keyway 156 containing the broken key portion 270. The second and distal end 318 includes a jaw section 320 having a jaw surface 322 contoured for gripping a surface area of a broken key portion 270, and for following an at least one key bitting slope S1 on the broken key portion 270, and for maximizing a contact area between the jaw surface 322 and any surface area on the broken key portion. The jaw surface 322 includes friction means 324 for enhancing jaw grip.

As illustrated clearly in FIGS. 3 and 4, the friction means for example comprise a series of teeth 324 that are formed each at a tooth angle 326 so as to enable each tooth to have an attack angle into any surface positioned parallel to the friction surface 322. As illustrated, each tooth of the series of teeth 324 has a curved inner surface Ht for enabling the tip 317 thereof to grip and claw increasingly into the contact surface (e.g. into L1 or S1) when the tool member 314 is being pulled back out of the keyway 156, even when being pulled out horizontally. As further shown, the teeth 324 are formed all along the jaw 320 and in decreasing teeth size towards the very tip 318 of the tool member 314.

The tool member 314 is generally flat including first and second sides 328, 329 a first edge 334, and a second and opposite edge 336. The first edge 334 extends from the first end 316 to the second and distal end 318 of the tool member 314, and the second and opposite edge 336 includes the jaw section 320. The jaw surface 322 extends diagonally from the second and opposite edge 336 to the first edge 334 of the tool member, and includes the friction means or teeth 324 for gripping a surface area such as a corner lip L1 or the key bitting slope S1 of the broken key portion 270. Although the friction means on the friction surface 322 are described for example as teeth 324, such friction means equally can be suitable surface abrasions, surface texturing means or surface roughening means.

As further illustrated, the extractor tool 310, 311 can be seen as including (a) a mid-portion 339 (b) the handle portion 312 connected to the mid-portion 339 and extending rearwards of the mid-portion; and (c) the tool portion 314 connected to, and extending forwardly from, the second and opposite end of the mid-portion 339. The tool portion 314 has a first longitudinal axis 342, and the distal end 318 includes the extracting jaw section 320 having the friction surface 322 for contacting and gripping the broken key portion 270 within the keyway 156. As illustrated in FIGS. 1-3, the friction surface 322 is angled at an angle 323 relative to the longitudinal axis 342, and is contoured, for maximizing contact thereof with contact surface segments of the broken key portion, for example with the corner lip L1 or slope S1 of a key bitting on the broken key portion 270. It should be noted that when looking at the single-axis acting device extractor tool 310, 311 from the handle towards the distal end 318, in both FIGS. 1 and 2, the bend, or bend 352 of the mid-portion 339 is to the left or first side 360 of the axis 344, 344′ in FIG. 1, but to the right or second side 362 of the same axis in FIG. 2. This phenomenon of this design is important in the creation of the dual-axes acting, right-over-left (ROL) and left-over-right (LOR) embodiments 330 and 340 of the extractor tool 300 of the present disclosure (to be described below).

In accordance with one aspect of the present disclosure, the single-axis acting first embodiment of the extractor tool 300 generally is also suitable for effectively extracting a removable piece (broken key portion 270) from within a recess (keyway 156) in a member (lock plug 154). As illustrated in FIGS. 1-3 and 4, and described above, the extractor tool 300 includes (a) the handle portion 312 extending longitudinally and having a vertical axis 344 and a second longitudinal axis 344′ coincident with the longitudinal axis 344; and (b) the mid-portion 339 having a third longitudinal axis 350. The mid-portion 339 is connected to the handle portion 312 and includes the bend 352 extending at a first angle 354 to the vertical axis 344 for enhancing positioning of the jaw section 320, by leveraging manipulation of the handle portion 312; and (c) the tool portion 314 is connected to, and extends forwardly from the mid-portion 339, and at a second angle 356, to the third longitudinal axis 350 of the mid-portion.

The tool portion 314 has the first side surface 328, the second and opposite side surface 329, the first longitudinal axis 342 substantially parallel to the second longitudinal axis 344′, and the distal end 318 including the extracting jaw 320 having the friction surface 322 contoured for contacting and gripping the removable piece or broken key portion 270 (FIGS. 18, 19) within the recess or keyway 156.

As shown in FIG. 2, the bend 352 of the mid-portion 339 is in the first direction to a first side 360 of the vertical axis 344 when the extractor tool 311 is placed on a surface with the first side surface 328 of the tool portion 314 facing down. On the other hand, as shown in FIG. 1, the bend 352 of the mid-portion 339 is in a second direction to the second side 362 of the vertical axis 344 when the extractor tool 310 is placed on a surface with the second side surface 329 of the tool portion 314 facing down.

The extractor tool 310, 311 as such is made from rolled spring steel for providing the strongest lateral strength possible during use. Such lateral strength from spring steel is greatly superior to that of conventional tools formed by forging or by stamping methods.

As further shown in FIG. 3B, the tool portion 314 of the extractor tool 310, 311 has a thickness T3 that is small or thin enough to allow the tool portion 314 to be insertable into and through the warded portion 140 (FIG. 13) of a lock's keyway 156. The warded portion 140 normally is very narrow for restricting what keys 202 (FIGS. 9-11D) will or will not fit into what lock. Still referring to FIG. 3B, the tool portion 314 of the extractor tool 310, 311 also has a width or operating height W2 that is short enough to allow it to enter into the straight blade receiving portion 182 (FIG. 14B) of the keyway, usually the portion that receives the bladed section 230 (FIG. 10A) of the shaft portion, for example of the key 202.

Thus as shown in FIGS. 15-16 for example, in a pin tumbler lock 150, the width or operating height W2 of the extractor tool 310, 311 is sized so that it can enter the keyway 156 where only the blade section 230 of the key normally enters, as well as below the lowest or at-rest point 170 of the lowest released pins or wafers 162 blocking a broken key portion 270 within the keyway. As pointed out above, the thickness T3 of the tool member or portion 314 must also be thin enough to allow it to enter the key blade portion 182 of the keyway. However, the thickness T3 must also be large enough to enable its top edge 334 to support and hold up or open any dustcover or flap [not shown] normally found at the outer end 158 of an automotive lock for example. Also, the nose or tip 319 (FIG. 4) of the second and distal end 318 of the tool portion 314 of the extractor tool 310, 311 is pointed for enabling it to easily pry under any pins or wafers 163 (FIGS. 18 and 19) that are partially or fully still resting on the broken key portion 270 within the keyway 156.

Again, the tool portion 314 of the extractor tool 310, 311 has an angled or sloping jaw 320 that is contoured so as to be able, for example, to follow and mirror the rising or inclining slope S1 of a cut or bitting 250 on a broken key portion 270. This allows much or most of the jaw slope or surface 322 of the extractor tool to be positionable parallel with a contact surface area such as the corner lip L1 or the inclining slope S1. The sloping jaw 320 has a multitude of small, sharpened and angled teeth 324 that are formed into it so that when the sloping jaw 320 is positioned at a tooth angle 326 (FIG. 3A) against a segment, such as the inclining slope S1 of the broken key portion 270, these teeth 324 will be angled such that they bite into such segment.

The arrangement and action of these teeth 324 are much like a chisel chiseling into a work surface at an angle with a sharpened wood chisel being run over the work surface. As such, the teeth 324 will dig into the surface of the segment of the broken key portion 270 when the extractor tool is being pressed down against the broken key portion while simultaneously being pulled backwards and out of the keyway 156. In fact, as described above each tooth of the teeth 324 has the curved inner surface Ht for enabling the tip 317 of the tooth to grip and claw increasingly into the contact surface (e.g. into the corner lip L1 or slope S1) when the tool member 314 is being pulled out of the keyway 156, even when being puled out horizontally.

Referring in particular to FIGS. 3 and 4, they are enlarged illustrations of the contoured friction jaw 320 and of the distal end 318 of the tool portion 314 of each single-axis acting device 310, 311 whether to be used as is, or assembled into a dual-axes acting mechanism 330, 340, or even into a triple-axes acting mechanism 500 (FIGS. 29-35).

The tooth angle 326 as such is desirable for enabling the sloping jaw 320 to grab onto any part of a key cut or bitting including the corner lip L1 where the break 272 occurs (FIGS. 19-21) as well as the inclining slope or ramp S1. The corner lip L1 of course is any remnant of the root or flat 258 of the deepest cut where the break 272 occurred. Such grabbing occurs because the combination of sloping jaw 320 of the tool, the tooth angle 326 and hook nature of the curved surface Ht (FIG. 4) of the teeth, always results in an angular attack by the teeth 324 on any surface against which the jaw 320 is positioned. With the first or single tool embodiment, 310, 311, 330, 340, the nose or tip 319 of the distal end 318, as described above, is pointed (FIG. 4) in order to allow it to pry and to penetrate under pins or wafers 163 still resting on the broken key portion 270.

Referring now to FIGS. 5 and 6, the dual-axes acting, right-over-left and left-over-right embodiments 330 and 340 of the extractor tool 300 of the present disclosure are illustrated. The left-over-right (LOR) version 330 is assembled by first laying the tool 311 of FIG. 2 down on a surface, then laying the tool 310 of FIG. 1 on top of it, such that the jaw sections 320, 320′ thereof are opposite and facing each other. The two tools 310, 311 are then pivotably mounted together at pivot 370.

Use of the left-over-right (LOR) version thereof is illustrated in FIG. 7 where when the tool 330 is held on edge (with a right side jaw and a left side jaw) as well as open for gripping a piece between the jaws 320, 320′, the left side jaw of 310 will be up for coming down into the grip, and the right side jaw of 311 will be down for moving up into the grip. This is useful for extracting from left-over-right keyways, a broken key portion of a dual-edge cut key 204 (FIGS. 11A-11D) that has a top edge left blade portion 234 defined by a waisting groove 232 on the upper right side of the key blank, and a bottom edge blade portion 236 defined by a waisting groove 232 on the lower left side of the key blank.

On the other hand, the right-over-left (ROL) version 340 is assembled by first laying the tool 310 of FIG. 1 down on a surface, then laying the tool 311 of FIG. 2 on top of such that the jaw sections 320 thereof are opposite and facing each other. The two tools 310, 311 are then pivotably mounted together at pivot 370. Use of the right-over-left arrangement thereof is illustrated in FIG. 8 where when the tool 340 is held on edge (with a right side jaw and a left side jaw) as well as open for gripping a piece between the jaws 320, 320′, the right side jaw of 310 will be up for coming down into the grip, and the left side jaw of 311 will be down for moving up into the grip.

Operation of the tool 300 is illustrated in FIGS. 15-25, of which FIGS. 18-20 each illustrate a broken key portion 270 blocked within the keyway 156 by released pins or wafers 162, requiring extraction in accordance with the present disclosure. FIGS. 21-23 are schematic illustrations of several stages of broken key portion 270 extraction using the first embodiment, the single-axis acting device 310, 311 (FIGS. 1 and 2) of the present disclosure, while FIGS. 24-25 are schematic illustrations of stages of broken key portion 270 extraction using the second embodiment, dual-axes acting mechanism extractor tools 330, 340 (FIGS. 5 and 6) of the present disclosure.

As pointed out above, in the second, dual-axes acting mechanism embodiment 330, 340, two of the single-axis acting device 310, 311 are assembled together in a scissors manner at a pivot 370 for left-over-right 330, and right-over-left 340 keyway operations. These embodiments as such are very suitable for extracting broken key portions 270 of dual-edge cut keys 204 from left-over-right, and right-over-left keyways 156. To use either of these second embodiments 330, 340, the scissors pair is closed during insertion into the keyway 156, and after insertion the pair is opened so that the smooth outer or first edges 334, 334 (each a first edge of the single-axis acting device 310, here forming top and bottom edges), displace any released wafers or pins 162 that have fallen into their locking positions 170 blocking the broken key portion 270 within the keyway.

In each of the first and second embodiments as above, the tool portion 314 fits within the part of the keyway left behind by the removed unbroken key portion of the key. Because of this, the tool portion 314 is thin enough to fit through the gap in the warded section 140 (FIG. 13) of the keyway, and narrow enough to fit through under the lowest drop point 170 of the released pins or wafers 162 (FIG. 15).

As such, it is intended and it is possible with one hand (a) to insert the tool portion 314 of the extractor tool 310, 311, 330, 340 below the released pins 162 into the keyway and into contact with the broken end 272 of the broken key portion 270; (b) to raise and if need be, angle the extractor tool while lifting the released blocking pins or wafers 162 out of the way of the broken key portion (see FIGS. 21-23); (c) to move the extractor tool portion 314 forwardly, angling where necessary, in order to pry underneath any partially supported pins 163 on the broken key portion; and to position the friction surface 322 of the contoured jaw 320, 320′ of the tool portion against a surface of a segment, such as a corner lip L1 or the rising or inclining slope S1, of the broken key portion 270; (d) if required, to use the sharpened points or tips 317 of the teeth 324 to grip such a surface; (e) then to press down and clamp onto such surface; and (f) to then pull backwardly while still pressing down, thereby withdrawing the broken key portion 270 from the keyway, with the first or top edge 334 of the tool portion 314 keeping the released but lifted pins or wafers 162 out of the way.

Accordingly, a method of the present disclosure is suitable for extracting a broken key portion 270 from a lock keyway having two spaced apart opposing side surfaces 172, 173, two spaced apart opposing edges 174, 175, a series of lock tumblers 160, and a longitudinal axis 185. The broken key portion includes a broken end 272 and potential contact surface areas including a corner lip L1 and at least one key bitting 250 having a key bitting slope S1. The method includes (a) longitudinally inserting into the lock keyway 156 the tool portion of an extractor tool having a distal tip 318, a first edge 334, and a second edge 336 including an extracting jaw 320 having a friction surface 322 for contacting a segment of the surface of the broken key portion, where the extracting jaw is contoured relative to the key bitting slope S1 for maximizing contact between the friction surface thereof and the key bitting slope within the lock keyway; (b) contacting the broken end 272 of the broken key portion with the distal tip; (c) moving the first edge 334 of the extractor tool towards one of the two spaced apart and opposing edges of the lock keyway; (d) further moving the distal tip 318 and the contoured friction surface 322 longitudinally into the keyway 156 and the contoured friction surface 322 into a contoured mating relationship with the key bitting slope S1; and (e) simultaneously pressing the contoured friction surface 322 into the key bitting slope S1 and pulling the extractor tool 310, 311, 330, 340 longitudinally back out of the keyway, thereby gripping the key bitting slope and extracting the broken key portion out of the keyway.

The method includes using the first edge 334 of the extractor tool for moving released and interfering tumblers 162 back out of the keyway during longitudinally inserting into the keyway. It also includes inserting a thin portion of the distal tip 318 through a clearance gap between one of the spaced apart and opposing edges of the keyway and an apex 256 of the key bitting slope S1. The longitudinally inserting function comprises inserting a first one 310 and a second one 311 of the single-axis acting devices, as a dual-axes acting scissors mechanism, with each device 310, 311 having a distal tip, a first edge, and a second edge including an extracting jaw 320, 320′ having a friction surface contoured relative to a key bitting slope of the at least one key bitting on the broken key portion for maximizing contact with, and grip of, the broken key portion within the lock keyway.

The function of moving the first edge of the extractor tool towards one of the two spaced apart and opposing edges includes contacting and displacing any released and interfering tumblers 162 of the series of tumblers, intruding into the keyway upstream of the broken end 272 of the broken key portion 270 relative to tool insertion. That of further moving the distal tip 318 and the contoured friction surface 322 longitudinally into the keyway includes further contacting and displacing any tumblers 163, of the series of tumblers, sitting in a key bitting 250 on the broken key portion 270 downstream of the broken end 272 of the broken key portion, relative to tool insertion. The first one and the second one of the single-axis acting devices are attached together pivotably at a pivot 370 in a scissors manner, and the simultaneous pressing and pulling function comprises closing handle portions of the first one and of the second one of the single-axis acting devices.

The method further includes closing handle portions of the first one and of the second one of the single-axis acting devices before longitudinally inserting the distal tips thereof into the keyway. Moving the first edge comprises opening the handle portions of the first one and of the second one of the single-axis acting devices after longitudinally inserting. The keyway includes a vertical axis and the first one and the second one of the single-axis acting devices are attached in a first manner so that when longitudinally inserted, the first one of the single-axis acting devices is offset to a first side of the vertical axis, and the second one of the single-axis acting devices is offset to a second and opposite side of the vertical axis. The keyway also includes a vertical axis and the first one and the second one of the single-axis acting devices are attached in a second manner so that when longitudinally inserted, the first one of the single-axis acting devices is offset to the second and opposite side of the vertical axis, and the second one of the single-axis acting devices is offset to the first side of the vertical axis.

Referring now to FIGS. 28-35, a triple-axes acting, third embodiment and operation thereof, of the extractor tool of the present disclosure are illustrated generally as 500. As illustrated, this embodiment 500 is suitable for extracting, from a recess, removable items including heavy items and items that can and may tend to rotate within the recess, items such as broken drill bits 570. Referring in particular to FIG. 28, this version 500 of the extractor tool is a triple-axes acting mechanism as shown, including three single-axis acting devices 310A, 310B, 311 that are attached together pivotably at pivot 507 for opening and closing movements in a scissors-like manner. Although they are shown as 310A, 310B, 311, they can equally be 311A, 311B, 310 based on the left-over-right and right-over-left assembly technique as discussed above.

As illustrated, an acting axis A1 of one (311) of the three single-axis acting devices 311, 310A, 310B, as attached, is offset from and apposite relative to the acting axes A2, A3 of the other two, (310A, 310B), of the three single-axis acting devices. The three devices A1, A2, A3 are attached as shown so that the contoured jaw section 320′ of the one of the three single-axis acting devices is apposite to and facing contoured jaw sections of the other two of the three single-axis acting devices.

As illustrated in FIGS. 1 and 2, and described above with reference to the first and second embodiments, each single-axis acting device 311, 310A, 310B has (i) a handle member 312 and (ii) a tool member 314. The tool member 314 has a first end 316 for connecting to the handle member 312, and a second and distal end 318 for inserting into a recess containing the removable item 570 (drill bit), 571 (sphere-like), 573 (flat). The second and distal end 318 includes the jaw section 320 having a jaw surface 322 contoured for following a contact surface on the removable item, and for maximizing a contact area between the jaw surface 322 and such contact surface. The friction means for example comprise a series of teeth 324 that are formed each at a tooth angle 326 and including a curved surface Ht so as to enable each tooth to have an attack angle into any surface, such as the contact surface, positioned parallel to the friction surface 322.

The tool member 314 is generally flat including first and second sides 328, 329 a first edge 334, and a second and opposite edge 336. The first edge 334 extends from the first end 316 to the second and distal end 318 of the tool member 314, and the second and opposite edge 336 includes the jaw section 320, 320′. The jaw surface 322 extends diagonally from the second and opposite edge 336 to the first edge 334 of the tool member, and includes the friction means or teeth 324 for gripping the contact surface of the removable item.

The acting axis A1 as described above is located apposite to and between the acting axes A2 and A3 in order to enable removal of the removable item in a torque-free manner. The torque-free manner of the tool 500 is illustrated comparatively in FIGS. 29-35. (FIG. 31), using a tool with only two offset jaws along offset axis A1 and A2, will undesirably result in a grip-defeating torque 550 as shown. Similarly as shown in FIG. 34, an attempt to grip a rotatable or movable item like a plate or flat piece 573 (FIG. 34) using a tool with only two offset jaws along offset axis A1 and A2, will undesirably also result in a grip-defeating torque 551 as shown.

On the other hand, using the triple-axis acting mechanism of the present disclosure as shown in FIGS. 29, 30, 32, 33 and 35, with its three axes A1, A2, A3 arranged as shown, results in a zero-torque or torque free and effective grip on a drill bit 570, a sphere 572 and a flat item 573. In each of these cases, an effective grip is important for enabling extraction of such items from a recess.

In particular, as illustrated in FIG. 30, the triple-axis acting mechanism of the present disclosure with its three axes A1, A2, A3 arranged as shown, is very suitable for extracting a broken skeleton key portion 208, in a zero-torque or torque free and effective grip manner, from a skeleton lock keyway.

As can be seen, there has been provided an extractor tool of the present disclosure that is suitable for extracting from a keyway a broken key portion of a cut key where the broken key portion includes a contact surface segment such as a corner lip or a key bitting slope. The extractor tool of the present disclosure includes a handle member; and a tool member having a first end for connecting to the handle member, and a second and distal end for inserting into the keyway containing the broken key portion. The second and distal end includes a contoured jaw section having a jaw surface contoured for following a key bitting slope on the broken key portion and for maximizing a contact area between the contoured jaw section and the contact surface.

There has also been provided a method that is suitable for extracting from a lock keyway having two spaced apart opposing side surfaces, two spaced apart opposing edges, a series of lock tumblers, and a longitudinal axis, a broken key portion including a broken end and a key bitting having a key bitting slope. In addition to the many other aspects as claimed, the method includes (a) longitudinally inserting into the lock keyway an extractor tool having a distal tip, a first edge, and a second edge including an extracting jaw having a friction surface contoured relative to the key bitting slope for maximizing contact between the friction surface and the key bitting slope within the lock keyway; (b) contacting the broken end of the broken key portion with the distal tip; (c) moving the first edge of the extractor tool towards one of the two spaced apart and opposing edges of the lock keyway; (d) further moving the distal tip and the contoured friction surface longitudinally into the keyway and the contoured friction surface into a contoured mating relationship with the key bitting slope; and (e) simultaneously pressing the contoured friction surface into the key bitting slope and pulling the extractor tool longitudinally back out of the keyway, thereby gripping the key bitting slope and extracting the broken key portion out of the keyway.

1. An extractor tool for extracting, from a keyway, a broken key portion of a cut key, the broken key portion including a contact surface area, the extractor tool comprising a single-axis acting device including:
(a) a handle member; and
(b) a tool member having a first end for connecting to said handle member, and a second and distal end for inserting into the keyway containing the broken key portion, said second and distal end including a contoured jaw section for acting along a single axes in contacting said contact surface area on said broken key portion, and for maximizing a contact area between said contoured jaw section and said contact surface area, said contoured jaw section being contoured to follow said contact surface area on said broken key portion, and including friction means covering a wide area of said contoured jaw section.

2. The extractor tool of claim 1, wherein said friction means are formed from a start of said jaw section through to a tip of said tool member for enabling multiple point gripping of said contact surface area of said broken key portion.

3. The extractor tool of claim 1, wherein said tool member is generally flat including first and second sides, a first edge, and a second and opposite edge.

4. The extractor tool of claim 1, wherein said tool member is made from spring steel for providing lateral tool strength.

5. The extractor tool of claim 1, wherein said distal tip is pointed for prying under tumbler pins resting against any surface area of the broken key portion.

6. The extractor tool of claim 2, wherein said friction means comprise a series of teeth.

7. The extractor tool of claim 3, wherein said first edge extends from said first end to said second end of said tool member, and said second and opposite edge includes said jaw section.

8. The extractor tool of claim 3, wherein said jaw section extends diagonally from said second and opposite edge to said first edge of said tool member.

9. The extractor tool of claim 3, wherein said tool member has a first side to second side thickness that is narrow enough for enabling it to be insertable through a narrow warded portion of a keyway.

10. The extractor tool of claim 3, wherein said tool member has a maximum first edge to second edge dimension that is short enough for enabling it to be insertable in a space within the keyway below released tumblers.

11. The extractor tool of claim 6, wherein said series of the teeth are formed all along said jaw and in decreasing teeth size towards a tip of said tool member.

12. The extractor tool of claim 6, wherein each tooth of said series of teeth is formed at an angle to said contoured surface of said contoured jaw.

13. The extractor tool of claim 6, wherein each tooth of said series of teeth has a curved inner surface for enabling a tip thereof to grip and claw increasingly into said contact surface area.

14. An extractor tool comprising:
(a) a mid-portion having a first end and a second and opposite end;
(b) a handle portion connected to said first end of said mid-portion and extending rearwards of said mid-portion; and
(c) a tool portion connected to, and extending forwardly from, said second and opposite end of said mid-portion, said tool portion having a longitudinal axis, and a distal end including an extracting jaw having a friction surface for contacting and gripping a broken key portion within a keyway, said friction surface being angled relative to said longitudinal axis, and being contoured, for maximizing contact thereof with a slope of a key bitting on the broken key portion.

15. An extractor tool for extracting a removable piece from within a recess, the extractor tool comprising:
(a) a handle portion extending longitudinally and having a vertical axis and a first longitudinal axis;
(b) a mid-portion having a second longitudinal axis, said mid-portion being connected to said handle portion and including a bend extending at a first angle to said vertical axis for enhancing positioning of a tool portion by leveraging manipulation of said handle portion; and
(c) a tool portion connected to, and extending forwardly from said mid-portion and at a second angle to said second longitudinal axis, said tool portion having a first side surface, a second and opposite side surface, a third longitudinal axis substantially parallel to said first longitudinal axis, and a distal end including an extracting jaw having a friction surface angled relative to said third longitudinal axis for contacting and gripping the removable piece within said recess.

16. The extractor tool of claim 15, wherein said bend of said mid-portion is in a direction to a first side of said vertical axis when the tool is placed on a surface with said first side surface of said tool portion facing down.

17. The extractor tool of claim 15, wherein said bend of said mid-portion is in a direction to a second side of said vertical axis when the tool is placed on a surface with said second side surface of said tool portion facing down.

18. The extractor tool of claim 15, wherein said friction surface is contoured relative to a slope of a key bitting on the broken key portion for maximizing contact thereof with said slope.

19. An extractor tool for extracting, from a keyway, a broken key portion of a cut key, the broken key portion including at least two opposite key bitting slopes, the extractor tool comprising:
(a) a dual-axes acting mechanism including two single-axis acting devices attached together pivotably for opening and closing movements in a scissors manner, (b) an acting axis of one of said two single-axis acting devices as attached being offset from and apposite relative to that of the other of said two single-axis acting devices;
(c) each said single-axis acting device having:
(i) a handle member and;
(ii) a tool member, said tool member including a first end for connecting to said handle member, and a second and distal end for inserting into the keyway containing the broken key portion, said second and distal end including a contoured jaw section contoured to follow said one of said at least two opposite key bitting slopes on said broken key portion, and said contoured jaw section including friction means, thereby enabling said dual-axes mechanism to make two offset and apposite jaw-contacts, one with each key bitting slope on each edge of a double-edge broken key portion for extraction.

20. The extractor tool of claim 19, wherein said friction means comprise a series of angled teeth.

21. The extractor tool of claim 19, wherein each tooth of said series of teeth has a curved inner surface for enabling a tip thereof to grip and claw increasingly into said contact surface area.

22. The extractor tool of claim 21, wherein said bend of said mid-member is in a first direction to a first side of said vertical axis when a single-axis acting device is placed on a surface with a first side surface of said tool member facing down.

23. The extractor tool of claim 21, wherein said bend of said mid-member is in a second direction to a second side of said vertical axis when a single-axis acting device is placed on a surface with said second side surface of said tool member facing down.

24. The extractor tool of claim 21, wherein for up and down positioned keyways, said two single-axis acting devices are attached as a right side device and a left side device for right-over-left (ROL) keyways, wherein movement of said right side device during closing of said dual-axes mechanism is from up to down, and movement of said left side device during closing of said dual-axes mechanism is from down to up.

25. The extractor tool of claim 21, wherein for up and down positioned keyways, said two single-axis acting devices are attached right-to-left, comprising a right side device and a left side device, for left-over-right (LOR) keyways wherein movement of said left side device during closing of said dual-axes mechanism is from up to down, and movement of said right side device during closing of said dual-axes mechanism is from down to up.

26. A method of extracting from a lock keyway having two spaced apart opposing side surfaces, two spaced apart opposing edges, a series of lock tumblers, and a longitudinal axis, a broken key portion, the broken key portion including a broken end and a contact surface area such as a key bitting having a key bitting slope, the method comprising:
(a) longitudinally inserting into said lock keyway a single-axis acting device having a distal tip, a first edge, and a second edge including an extracting jaw having a friction surface contoured relative to said key bitting slope for maximizing contact between said friction surface and said key bitting slope within said lock keyway;
(b) contacting said broken end of said broken key portion with said distal tip;
(c) moving said first edge of said single-axis acting device towards one of said two spaced apart and opposing edges of said lock keyway;
(d) further moving said distal tip and said contoured friction surface longitudinally into said keyway and said contoured friction surface into a contoured mating relationship with a surface area of the broken key portion; and
(e) simultaneously pressing said contoured friction surface into said surface area of the broken key portion and pulling said single-axis acting device longitudinally back out of said keyway, thereby gripping and extracting said broken key portion out of said keyway.

27. The method of claim 26, including using said first edge of said single-axis acting device for moving interfering tumblers back out of said keyway during longitudinally inserting into said keyway.

28. The method of claim 26, including inserting a pointed portion of said distal tip through a clearance gap between said one of said spaced apart and opposing edges of said keyway and an apex of said key bitting slope.

29. The method of claim 26, wherein said longitudinally inserting function comprises inserting a first one and a second one of said single-axis acting device pivotably assembled for movement in a scissors manner.

30. The method of claim 26, wherein moving said first edge of said single-axis acting device towards one of said two spaced apart and opposing edges includes contacting and displacing any interfering tumblers, of said series of tumblers, intruding into said keyway upstream of said broken end of said broken key portion relative to tool insertion.

31. The method of claim 26, wherein further moving said distal tip and said contoured friction surface longitudinally into said keyway includes further contacting and displacing any tumblers, of said series of tumblers, sitting in a key bitting on said broken key portion downstream of said broken end of said broken key portion relative to tool insertion.

32. The method of claim 29, wherein said simultaneous pressing and pulling function comprises closing handle portions of said first one and said second one of said single-axis acting device.

33. The method of claim 32, including closing handle portions of said first one and said second one of said single-axis acting device before longitudinally inserting the distal tips thereof into said keyway.

34. The method of claim 33, wherein radially moving said first edge comprises opening the handle portions of said first one and said second one of said single-axis acting device after longitudinally insertion.

35. The method of claim 33, wherein said keyway includes a vertical axis and said first one and said second one of said single-axis acting device are attached in a first manner so that when longitudinally inserted, said first one of said single-axis acting device is offset to a first side of said vertical axis, and said second one of said single-axis acting device is offset to a second and opposite side of said vertical axis.

36. The method of claim 35, wherein said keyway includes a vertical axis and said first one and said second one of said single-axis acting device are attached in a second manner so that when longitudinally inserted, said first one of said single-axis acting device is offset to said second and opposite side of said vertical axis, and said second one of said single-axis acting device is offset to said first side of said vertical axis.

37. An extractor tool for extracting, from a recess, removable items including heavy items and items that can rotate within the recess, the extractor tool comprising:
(a) a triple-axes acting mechanism including three single-axis acting devices attached together pivotably for opening and closing movements in a scissors manner,
(b) an acting axis of one of said three single-axis acting devices as attached being offset from and apposite relative to acting axes of the other two of said three single-axis acting devices;
(c) each said single-axis acting device having:
(i) a handle member and;
(ii) a tool member, said tool member including a first end for connecting to said handle member, and a second and distal end for inserting into the recess containing the removable item, said second and distal end including a contoured jaw section for maximizing a contact area between said contoured jaw section and said removable item, said contoured jaw section including friction means covering a wide area of said contoured jaw section, thereby enabling said triple-axes mechanism to make three offset jaw-contacts, one contact across from two contacts with said removable item for removal in a torque-free manner.

38. The extractor tool of claim 37, wherein said friction means comprise a series of angled teeth.

39. The extractor tool of claim 37, wherein said acting axis of said one of said three single-axis acting devices as attached is located apposite to and between said acting axes of said other two of said three single-axis acting devices.

40. The extractor tool of claim 38, wherein each tooth of said series of teeth has a curved inner surface for enabling a tip thereof to grip and claw increasingly into said contact surface area.
